(19) United States
(12) Patent Application Publication
(10) Pub. No.: US 2005/0134820 A1
(43) Pub. Date: Jun. 23, 2005

(54) Method for exposing a substrate, patterning device, and lithographic apparatus

(75) Inventors: Heine Melle Mulder, Eindhoven (NL); Antonius Johannes Jospehus Van Dijsseldonk, Hapert (NL); Erik Roelof Loopstra, Heeze (NL); Uwe Mickan, Veldhoven (NL); Johannes Catharinus Hubertus Mulkens, Maastricht (NL); Harm-Jan Voorma, Zaltbommel (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 10/740,830

(22) Filed: Dec. 22, 2003

(51) Int. Cl. G03B 27/54

(52) U.S. Cl. 355/67; 355/77

(57) ABSTRACT

A method using a lithographic apparatus comprising a reflective integrator is claimed that optimizes the exposure of features on a target area of a substrate, when the features make an angle between 5 and 85 degrees with respect to the target area. The method comprises rotating the reflective integrator with respect to the target area providing a rotated mirror-symmetric pupil shape, which is implemented by either rotating the substrate or rotating the reflective integrator with respect to the machine or the patterning device. The patterning device comprises a maximum usable area and a patterned area which are rotated with respect to each other if a rotated substrate is employed. The method can be used in single exposure or double exposure mode. A further advantage of the method of using a rotated wafer is that it can be used for exposing features on a substrate in any direction even when the projection system of the lithographic apparatus shows a preferred polarization direction.

### BACKGROUND OF THE INVENTION

1. Field of the Invention

The present invention relates generally to a method for exposing a substrate using a lithographic apparatus, a patterning device, a lithographic apparatus, and more particularly, to a method for projecting features onto a substrate by a projection system with a preferred polarization direction.

2. Description of the Prior Art

A lithographic apparatus is a machine that applies a desired pattern comprising features or structures or line patterns onto a target portion of a substrate. Lithographic apparatus can be used, for example, in the manufacture of micro structure devices such as integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g., comprising part of, one or several dies) on a substrate (e.g., a silicon wafer) that has a layer of radiation-sensitive material (resist). In general, a single substrate contains a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the projection beam in a given direction (the “scanning”-direction) while synchronously scanning the substrate parallel or anti-parallel to this direction.

Current structures on micro structure devices are often called ‘Manhattan structures’ since they are characterized by an orientation of the structures, line patterns, or features in mainly two perpendicular directions similar to a pattern of city streets. In current structure layout designs, these two directions are kept parallel to the respective boundary segments of a rectangular target exposure area on the substrate (die). By one convention, horizontal structures extend in an X-direction while vertical structures extend in a Y-direction. The width of the target portion is defined as the size of the rectangular area in the X-direction, and the height of the target portion is defined as the size of the rectangular area in the Y-direction. In lithographic scanners, the non-scanning direction is normally referred to as the X-direction while the scanning direction is referred to as the Y-direction.

### SUMMARY OF THE INVENTION

A recent development in the layout design of micro structures is the use of features with an orientation other than in the X- or Y-direction, i.e., line patterns extending in a direction that can make any angle between 0 and 90 degrees with respect to the X-direction. For example, the imaging of DRAM isolating structures may be optimized by using an angle between 20 and 30 degrees with respect to either the X- or Y-axis. Optimized imaging comprises for example an enhanced process latitude or increased depth of focus.

The imaging of structures with a certain orientation can be optimized by illuminating the structures on the mask with a projection beam having a certain corresponding angular intensity distribution. For example, the imaging of horizontal structures may be optimized by employing a projection beam containing substantially vertical angles. As the angular intensity distribution of the projection beam in a field plane corresponds to a spatial intensity distribution in a pupil plane (which may be called “pupil shape” or just “pupil”), a beam that contains substantially vertical angles corresponds to a pupil shape that has two high intensity regions separated from the optical axis in the Y-direction. The latter pupil shape is commonly referred to as dipole. The corresponding illumination mode is referred to as dipole illumination, in this particular case as dipole Y illumination. Similarly, the imaging of structures that make an angle α with the X-axis can be optimized by dipole illumination in which the pupil is rotated over the same angle α. In general, when the imaging of a certain structure is optimized by a certain pupil shape, then if the structure is rotated also the pupil shape should be rotated accordingly by an equal amount in order to maintain the same imaging performance.

Current lithographic apparatus comprise an illumination system for providing a projection beam of radiation of desired dimensions, having a desired intensity distribution and a desired angular intensity distribution. The illumination system comprises an integrator to improve the uniformity of the projection beam with regard to intensity and angular intensity distribution variations over a beam cross-section. The principle of an integrator is based on the creation of a plurality of secondary radiation sources or virtual secondary sources from a primary source, such that the beams originating from these secondary sources overlap at an intermediate field plane and average out. This averaging effect is called light integrating or light mixing.

One type of integrator is based on multiple reflections, referred to hereinafter as reflective integrator, and is embodied for example as a crystal rod made of quartz or calcium-fluoride (CaF₂) or as a hollow waveguide, the faces of which are made of reflective material. This type of integrator generally has a rectangular (often square) cross-section and parallel side faces. Multiple secondary light sources are formed via multiple internal (rod type) or external (waveguide) reflections of the incoming radiation beam. Each reflective surface preferably provides total reflection, but in practice the intensity of the reflected beam is decreased by a certain small amount after each reflection.

An inherent property of a reflective integrator having a rectangular cross-section is that the angular intensity distribution of a beam exiting the integrator is forced to be symmetric with respect to the side faces of the integrator. i.e., the pupil shape of a beam that enters the integrator can be any shape, but due to the mixing of rays of radiation that has either made an even or an uneven number of reflections in the reflective integrator, the pupil shape of the beam that exits the integrator is mirror-symmetric with respect to two perpendicular axes parallel to the respective boundary segments of the rectangular cross-section of the reflective integrator, these axes normally oriented in the X- and Y-direction.

A problem with current lithographic apparatus comprising a reflective type of integrator (rod or hollow waveguide) arises when the imaging needs to be optimized for structures that extend in directions other than in the X- and/or Y-direction. For these other directions, a pupil shape of the projection beam which is non-mirror-symmetric with respect to the X- and Y-axes would be optimal. Such a pupil shape may also be referred to as a rotated mirror-symmetric pupil shape, or simply as a rotated pupil shape. Current illumination systems with reflective integrators are constructed and arranged such that they can provide mirror-symmetric pupil shapes such as for example annular, dipole-X, dipole-Y, quadrupole, hexapole, octopole. However, these systems cannot provide non-mirror-symmetric pupil shapes such as monopole, rotated dipole, tripole, rotated quadrupole.

One aspect of embodiments of the present invention provides a method for exposing a substrate, a patterning device adapted for use in the method, and a lithographic apparatus comprising an illumination system with a reflective type of integrator (rod or waveguide) that may reduce the above problem encountered when optimizing the projection of structures or features that extend in a direction substantially different from the X- and/or Y-direction.

This and other features are achieved according to embodiments of the invention by using a method for exposing a substrate using a lithographic apparatus, the method including, providing a projection beam of radiation using an illumination system, the illumination system being part of a lithographic apparatus and comprising a reflective integrator disposed along an optical axis of the lithographic apparatus, the reflective integrator having a rectangular cross-section perpendicular to said optical axis, providing a patterning device constructed and arranged to impart the projection beam with a pattern in its cross-section, the patterning device comprising a patterned area, the patterned area comprising features that extend in at least one direction parallel to a boundary segment of said cross-section of said reflective integrator, when viewed in a common plane perpendicular to the optical axis, providing a substrate, the substrate comprising a radiation-sensitive layer and at least one target portion, said target portion being substantially rectangular, and providing a projection system constructed and arranged for projecting said patterned area onto said target portion, wherein during an exposure a first angle between a boundary segment of said cross-section of said reflective integrator and a boundary segment of said target portion is between 5 and 85 degrees, when viewed in a common plane perpendicular to the optical axis, said first angle being measured as a rotation around said optical axis.

By using the above method, the angular intensity distribution of the projection beam can effectively correspond to a rotated pupil shape even with the use of a reflective integrator. This combination of using a reflective integrator and having a non-mirror-symmetric pupil shape with respect to the X and Y-axes is new, because conventionally only mirror-symmetric pupil shapes with respect to the X and Y-axes could be provided. The combination is inventive, because previously it was generally thought that an illumination system with a reflective integrator could only provide mirror-symmetric pupil shapes.

According to a first aspect of the invention there is provided such a method of exposing a substrate, wherein said patterning device comprises a maximum usable area, the maximum usable area comprising said patterned area, and wherein during an exposure a second angle between a boundary segment of said target portion and a boundary segment of said maximum usable area is substantially equal to said first angle and wherein a third angle between a boundary segment of said cross-section of said reflective integrator and a boundary segment of said maximum usable area is substantially 0 degrees, when viewed in a common plane perpendicular to the optical axis, said second and third angles being measured as rotations around said optical axis.

The idea behind this first aspect of the invention is that instead of rotating a pupil, the substrate (wafer) is rotated in order to optimize the imaging of structures with a desired orientation. An advantage of this method is that a conventional lithography apparatus can be used to employ the method without or with minor hardware modifications. Moreover, the structures on the patterning device can be conventionally oriented in a direction parallel to the boundary segments of the maximum usable area, which makes the manufacturing process of the patterning device, such as a reticle, much easier.

This method can also be employed when the projection system has a preferred polarization direction such as for example a catadioptric projection system that comprises a polarizing beam splitter. Then the illumination system provides a projection beam which is linearly polarized in that preferred direction, the first and second patterns contain structures oriented in a direction corresponding to a direction optimal for imaging, and the substrate is rotated over an angle corresponding to the desired angle between first and second patterns on the substrate, for example 90 degrees.

According to a second aspect of the invention there is provided such a method and a lithographic apparatus for using such a method, wherein said patterning device comprises a maximum usable area, the maximum usable area comprising said patterned area, and wherein during an exposure a second angle between a boundary segment of said target portion and a boundary segment of said maximum usable area is substantially 0 degrees and wherein a third angle between a boundary segment of said cross-section of said reflective integrator and a boundary segment of said maximum usable area is substantially equal to said first angle, when viewed in a common plane perpendicular to the optical axis, said second and third angles being measured as rotations around said optical axis.

The idea behind this second aspect of the invention is that the reflective integrator is rotated with respect to the patterning device over any angle between 5 and 85 degrees, in order to optimize the imaging of structures with any desired orientation. The advantage is that any mirror-symmetric pupil shape that can be provided with a reflective integrator in its conventional orientation, such as for example dipole X, dipole Y, or quadruple, can hereby be provided in its rotated form thereby optimizing the imaging of structures oriented in a direction other than in X or Y. A further advantage of this solution is that the full functionality of the integrator is maintained. The amount of mixing of radiation due to multiple reflections in the reflective integrator is independent of the rotation of the integrator, and thus the improvement of uniformity by a reflective integrator is maintained.

According to a third aspect of the invention there is provided a patterning device adapted for use in the above method, wherein said patterning device comprises a maximum usable area, the maximum usable area comprising a patterned area, and wherein an angle between a boundary segment of said maximum usable area and a boundary segment of said patterned area is between 5 and 85 degrees, said angle being measured as a rotation around an axis perpendicular to the patterning device.

Usually the patterned area on a patterning device such as a mask or reticle is bounded by an opaque layer of for example chromium. The patterning device according to the invention thus has a patterned area which is rotated with respect to the maximum usable area of the patterning device. An advantage of this is that the structures on the patterning device can be conventionally oriented in a direction parallel to the boundary segments of the maximum usable area, which makes the manufacturing process of the patterning device, such as a reticle, much easier.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of 365, 248, 193, 157 or 126 nm) and extreme ultra-violet (EUV) radiation (e.g., having a wavelength in the range of 5-20 nm), as well as particle beams, such as ion beams or electron beams.

The term “patterning device” used herein should be broadly interpreted as referring to a device that can be used to impart a projection beam with a pattern in its cross-section such as to create a pattern in a target portion of the substrate. It should be noted that the pattern imparted to the projection beam may not exactly correspond to the desired pattern in the target portion of the substrate. Generally, the pattern imparted to the projection beam corresponds to a particular functional layer in a device being created in the target portion, such as an integrated circuit.

A patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure supports, i.e., bears the weight of, the patterning device. It holds the patterning device in a way depending on the orientation of the patterning device, the design of the lithographic apparatus, and other conditions, such as for example whether or not the patterning device is held in a vacuum environment. The support can be using mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device.”

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “lens” herein may be considered as synonymous with the more general term “projection system.”

The illumination system may also encompass various types of optical components, including refractive, reflective, and catadioptric optical components for directing, shaping, or controlling the projection beam of radiation, and such components may also be referred to below, collectively or singularly, as a “lens.”

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g., water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

### DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to a preferred embodiment of the invention;

FIG. 2 demonstrates the formation of a mirror-symmetric pupil shape by a reflective integrator.

FIG. 3 illustrates a method according to the invention for exposing a substrate by rotating the wafer substrate over an angle.

FIG. 4 shows an additional advantage and use of the method of rotating the wafer substrate when the projection system has a preferred polarization direction.

FIG. 5 illustrates a method according to the invention for exposing a substrate by rotating the reflective integrator over an angle.

### DETAILED DESCRIPTION OF THE PRESENT INVENTION

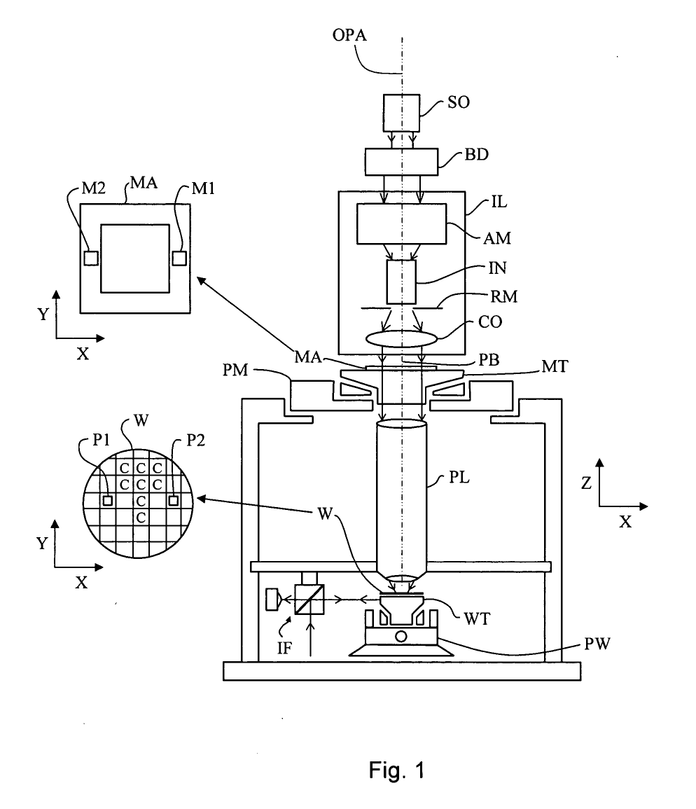

FIG. 1 schematically shows a lithographic apparatus according to a particular embodiment of the invention. The apparatus includes:
an illumination system (illuminator) IL for providing a projection beam PB of radiation (e.g., UV radiation or DUV radiation, i.e., electromagnetic radiation with a wavelength between 100 and 400 nm, for example 365, 248, 193, or 157 nm);
a support structure (e.g., a mask table) MT for supporting a patterning device (e.g., a mask or a reticle) MA and connected to first positioning means PM for accurately positioning the patterning device with respect to item PL;
a substrate table (e.g., a wafer table) WT for holding a substrate (e.g., a resist-coated wafer) W and connected to second positioning means PW for accurately positioning the substrate with respect to item PL; and
a projection system (e.g., a refractive projection lens) PL for imaging a pattern imparted to the projection beam PB by patterning device MA onto a target portion C (e.g., comprising one or more dies) of the substrate W.

As here depicted, the apparatus is of a transmissive type (e.g., employing a transmissive mask). Alternatively, the apparatus may be of a reflective type (e.g., employing a programmable mirror array of a type as referred to above).

As here depicted the subsequent optical elements or modules of the lithographic apparatus are disposed along a straight optical axis OPA. This means that the optical axis runs symmetrically through the center of the subsequent optical elements such as the integrator IN, condensor CO, and projection system PL. However, the optical axis may also comprise several contiguous straight segments oriented in different directions by using for example beam bending mirrors in order to change the layout and reduce the size of the whole apparatus.

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjustable components AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN (for example a reflective integrator such as a Quartz rod) and a condenser CO. The illuminator provides a conditioned beam of radiation, referred to as the projection beam PB, having a desired uniformity and intensity distribution in its cross-section. The illuminator IL further comprises a reticle masking unit RM that is used for defining the size of the area (slit) on the patterning device (mask or reticle) that is being illuminated by the projection beam. Usually, two of the blades define the size of the slit in the non-scanning direction, while two other blades are used for controlling the dose in the scanning direction. A conventional reticle masking unit therefore contains four independently movable blades, the blades overlapping each other or positioned adjacent to each other, and the blades positioned in a field plane after the integrator, for example immediately after the integrator, or adjacent to the patterning device.

The projection beam PB is incident on the mask MA, which is held on the mask table MT. Having traversed the mask MA, the projection beam PB passes through the lens PL, which focuses the beam onto a target portion C of the substrate W. With the aid of the second positioning means PW and position sensor IF (e.g., an interferometric device), the substrate table WT can be moved accurately, e.g., so as to position different target portions C in the path of the beam PB. Similarly, the first positioning means PM and another position sensor (not shown) can be used to accurately position the mask MA with respect to the path of the beam PB, e.g., after mechanical retrieval from a mask library, or during a scan. In general, movement of the object tables MT and WT are realized with the aid of a long-stroke module (coarse positioning) and a short-stroke module (fine positioning), which form part of the positioning means PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:

1. In step mode, the mask table MT and the substrate table WT are kept essentially stationary, while an entire pattern imparted to the projection beam is projected onto a target portion C in one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the projection beam is projected onto a target portion C (i.e., a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the projection beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

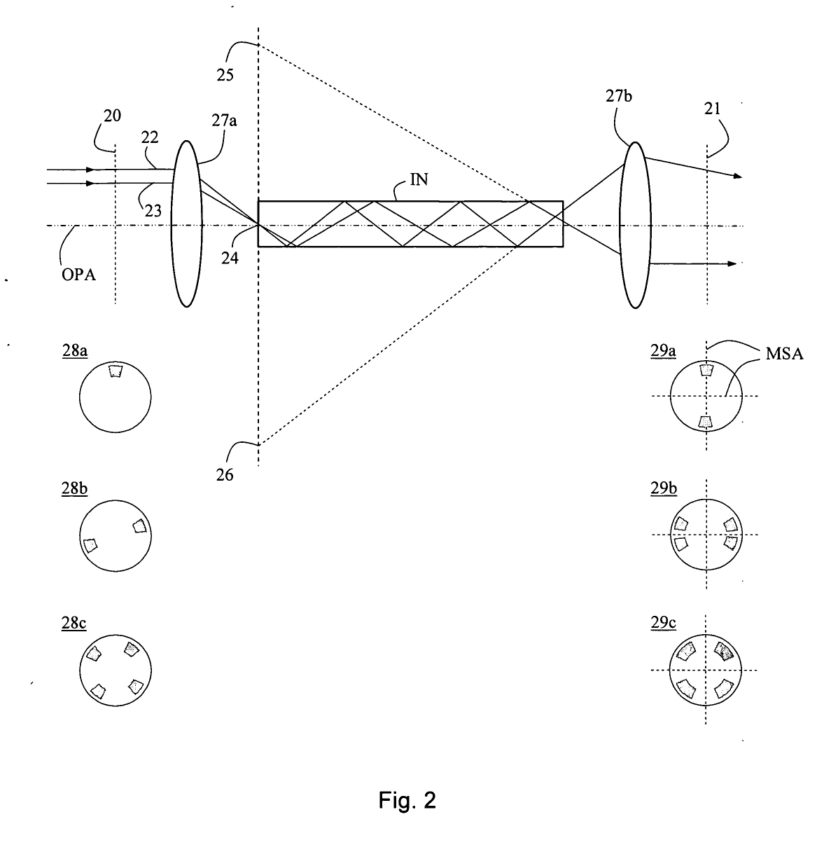

FIG. 2 illustrates the integrating or mixing effect of a reflective integrator IN, for example a rod made of quartz or CaF₂ having a rectangular cross-section, and the formation of a pupil that is mirror-symmetric with respect to two perpendicular central axes, said axes being parallel to respective boundary segments of the cross-section of said reflective integrator, when viewed in a common plane perpendicular to the optical axis.

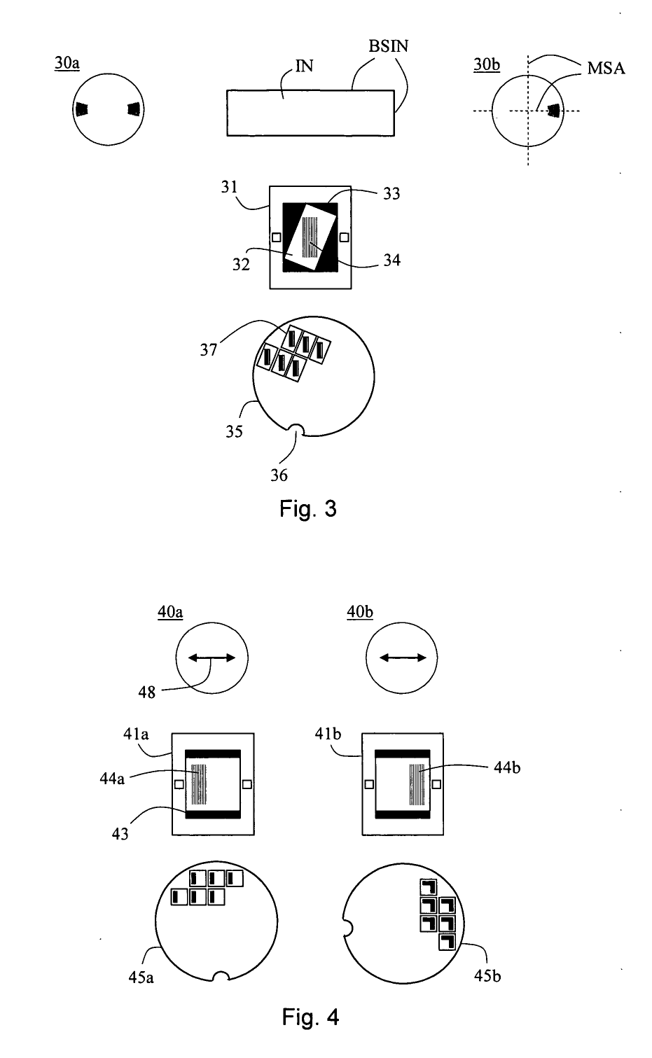

An incoming beam of radiation has an angular intensity distribution corresponding to a spatial intensity distribution in pupil plane 20 before the integrator IN. Before the integrator means upstream in the optical path; a beam of radiation first passes pupil plane 20 and next passes integrator IN. Two rays of radiation 22 and 23 of the incoming radiation beam are traced through the optical system comprising an incoupling lens 27a, an integrator IN, and an outcoupling lens 27b. The two parallel rays 22 and 23 are focused by incoupling lens 27a and form a primary radiation source 24. In this figure, the position of primary source 24 coincides with the entrance face of the integrator, but primary source 24 may also be located before or after the entrance face of the integrator, for example to reduce the local intensity at the entrance face. In the integrator, ray 22 is reflected 5 times at the horizontal faces of the integrator, and on exiting the integrator, ray 22 ends up with a mirrored direction. Note that also the position of ray 22 at the exit face differs from the position at the entrance face. Ray 22 can be regarded as originating from secondary source 26. Ray 23 is reflected 4 times at the horizontal faces of the integrator, and on exiting the integrator, ray 23 shows no change of direction. Ray 23 can be regarded as originating from secondary source 25. Effectively, the integrator creates a plurality of virtual secondary sources, the secondary sources illuminating the exit face of the integrator, thereby providing a mixing of the radiation beam and increasing the uniformity of the beam. In addition, rays of radiation that experience an uneven number of reflections at the horizontal faces of the integrator obtain a mirrored direction upon exiting the integrator. The same holds for the vertical faces of the integrator. This effect forces the spatial intensity distribution at pupil plane 21 after the integrator to be mirror-symmetric with respect to two perpendicular central axes MSA, said axes being parallel to respective boundary segments of the cross-section of the reflective integrator (referred to by BSIN in FIG. 3, not shown in FIG. 2). In this text, several directions of boundary segments and axes are compared which are physically defined in different planes. When such a comparison is made, these directions are defined when viewed in a common plane perpendicular to the optical axis OPA. This means that if the optical axis is bent, for example by 90 degrees in between the pupil plane 20 and the integrator, or in between the integrator and the plane of the reticle, these different planes are first aligned parallel as if they are viewed upon in the direction of the optical axis followed by the comparison of directions.

For example, a monopole pupil shape 28a before the integrator ends up as a dipole pupil shape 29a after the integrator, being mirror-symmetric with respect to axes MSA. A rotated dipole 28b ends up as a form of quadrupole 29b. Similarly a rotated quadrupole may end up as an octopole. A slightly rotated quadrupole 28c ends up as a quadrupole with poles that are extended over a wider angle 29c, but with a noticeably higher intensity in a center part of the resulting poles corresponding to the mirror-symmetric part of the pupil shape in 28c. Similarly, a slightly rotated dipole ends up as a dipole with poles extended over a wider angle. In summary, any incoming pupil shape ends up as a corresponding pupil shape that is mirror-symmetric with respect to the two axes MSA parallel to the side faces (boundary segments of the cross-section) of the integrator.

Note that an integrator rod when made of quartz has a refractive index different from 1, so that FIG. 2 does not correctly show the rays of radiation at the entrance and exit faces of the rod where refraction occurs. For a hollow waveguide, this refraction is obviously absent. However, for the purpose of this invention, this refraction is not relevant. In addition, the figures are drawn schematically and not to scale.

FIG. 3 illustrates the method according to the first aspect of the invention. Pupil shapes 30a and 30b, a cross-section of the integrator IN, a patterning device 31, and a wafer substrate 35 are depicted in a common plane corresponding to the plane of the paper perpendicular to the optical axis. The patterning device 31 comprises a rectangular patterned area 32 comprising a line pattern 34 (elongate features or structures) extending in a vertical direction. The direction of line pattern 34 is parallel to a boundary segment BSIN of the cross-section of the integrator IN, in this case parallel to the two opposing vertical boundary segments. The optimal pupil shape for such a vertical line pattern is for example a dipole X pupil 30a. For a horizontal line pattern, the optimal pupil shape may for example be a dipole Y. This pupil shape is unaffected by integrator IN which is conventionally oriented, and therefore ends up in a pupil plane after the integrator also as a dipole X pupil shape 30b. During an exposure, the patterned area 32 is imaged (projected) onto a rectangular target portion (die) 37 on a wafer substrate 35. The angle between the direction of the line pattern when projected on the substrate and a boundary segment of the target portion 37 is between 5 and 85 degrees, for example the angle is 45 or 30 degrees. The angle is further preferably an integer fraction of 90 degrees, such as 90 degrees divided by 2, 3, etc.

FIG. 3 shows the patterned area on the mask and the target portion on the wafer in the same orientation for better illustrating purposes and easier description of the invention. However, the image orientation on the wafer is normally inverted due to the inverting action of the demagnifying projection system. The integrator has a conventional orientation, i.e., the angle between a boundary segment of the cross-section of said reflective integrator and a boundary segment of the maximum usable area of the patterning device is substantially 0 degrees. The maximum usable area of the patterning device is normally a rectangular area, for example, 4 times the maximum target area on the substrate (die size) of a scanning exposure, corresponding to an area of for example 104×132 mm. The above method therefore provides optimized imaging of line patterns making an arbitrary angle with the edge (boundary segment) of the die. The line patterns can be isolated lines or dense lines, or may contain additional or assisting features.

Above, the method is described as being a single exposure method. However, the method can also be implemented as a double exposure method, rotating the wafer in between the two exposures. In addition, in between two exposures a process step such as etching or ion implantation may take place.

Furthermore, the method can be used in cases where the patterning device 31 comprises a critical line pattern in a direction making an angle with the X- and the Y-direction, i.e., a line pattern with minimum line width and spacing, and a non-critical line pattern in the X- or the Y-direction. The pupil shape is optimized for the critical line pattern, but also suffices for the non-critical line pattern. When imaged on a rotated wafer, the critical line pattern is imaged under an angle with respect to the edges of the die, whereas the non-critical line pattern is imaged parallel to the edges of the die.

For a rectangular maximum usable area, the maximum patterned area that can be used for two subsequent exposures has an octogonal boundary (not shown), the exact shape of this maximum patterned area depending on the amount of rotation, but still being substantially rectangular, 4 of the 8 line segments that define this octagon then coincide with the boundary segments of the maximum usable area. To avoid exposing unpatterned areas on the wafer, the mask 31 is provided with an opaque region such as a chromium border 33 shaped such that only the desired patterned area is exposed on the wafer. This is not a strict requirement, as there might be cases in double exposure applications where in this border area 33 only one of the two line patterns need to be imaged. Then the opaque border 33 may be decreased in size or even removed. When a die size is used which is small enough to fit, when rotated, completely in the maximum usable area, the target portion on the wafer can be kept rectangular and the filling efficiency of the complete wafer area is thereby optimized.

The actual rotation of the wafer can be accomplished in several ways. Conventionally, a wafer is prealigned relative to a wafer notch 36 before it is put on a wafer table (WT in FIG. 1). Providing an offset to this prealignment, the offset corresponding to a desired angle of rotation suffices to have the wafer in a rotated position as compared to an unrotated position, i.e., when the offset is zero. Alternatively, the wafer table can be constructed to have an additional degree of freedom to rotate around its axis. Depending on the specific application, single or double exposure, one or many rotations, one or more layers, etc. . . . the alignment marks on the wafer (P1 and P2 in FIG. 1) are customized. Extra alignment marks or rotated alignment marks can be used in order to accomplish optimal alignment of subsequent layers to be exposed.

An additional aspect of the method of rotating the wafer substrate in between two exposures is that it may solve the problem that occurs if the projection lens (PL in FIG. 1) has a preferred direction for the polarization of the projection beam. For instance, a catadioptric projection lens for 157 nm radiation that comprises a beam splitter is optimized for a linearly polarized projection beam, i.e., a projection beam of radiation which is polarized in substantially a single direction. Radiation with a polarization in other directions does not pass this projection lens or is strongly attenuated. However, such a linearly polarized projection beam is optimized for imaging structures in one direction only, which implies that the projection system is also optimized for imaging line patterns in one direction only. Now, using the method of the invention as described above, the wafer is rotated in between exposures such that the line patterns (or critical features) on the mask are oriented in the preferred direction, while the projected line patterns on the wafer can have any direction.

FIG. 4 illustrates how the above described additional aspect of rotating the wafer in between exposures when the projection system shows a preferred polarization direction is implemented. In a pupil plane 40a of the illuminator, the radiation beam is linearly polarized in the horizontal direction, depicted by double arrow 48. This is the preferred polarization direction which optimally passes the projection lens (PL in FIG. 1). The pupil shape in pupil plane 40a can have any shape, for example conventional, annular, or dipole X. Mask 41a contains a line pattern 44a with an orientation which is optimal for this horizontal polarization direction. A vertical pattern orientation is optimal with respect to transmission of the polarized radiation, but a horizontal direction can be optimal with respect to the interference of the radiation at wafer level. FIG. 4 illustrates a case when a vertical pattern orientation 44a is optimal. The patterned area on the mask is imaged onto several target portions on the wafer substrate. Then the wafer is rotated from rotational position 45a (notch down) to rotational position 45b (notch left) and the pattern on mask 41b is imaged onto the same target portions on the wafer. Again the polarization of the projection beam in pupil plane 40b is horizontal. In fact this horizontal orientation is optimal for every exposure with this configuration of the projection lens. Eventually, a pattern with both horizontal and vertical lines or structures is obtained on each target portion on the wafer. In this example, the amount of rotation is 90 degrees, corresponding to so called Manhattan structures, and corresponding to a square maximum overlapping target portion. Masks 41a and 41b have an opaque border 43 defining this square target portion. However, the invention is not limited to Manhattan structures. In principle, any desired orientation of the line pattern on the wafer can be imaged if the rotation of the wafer is set accordingly.

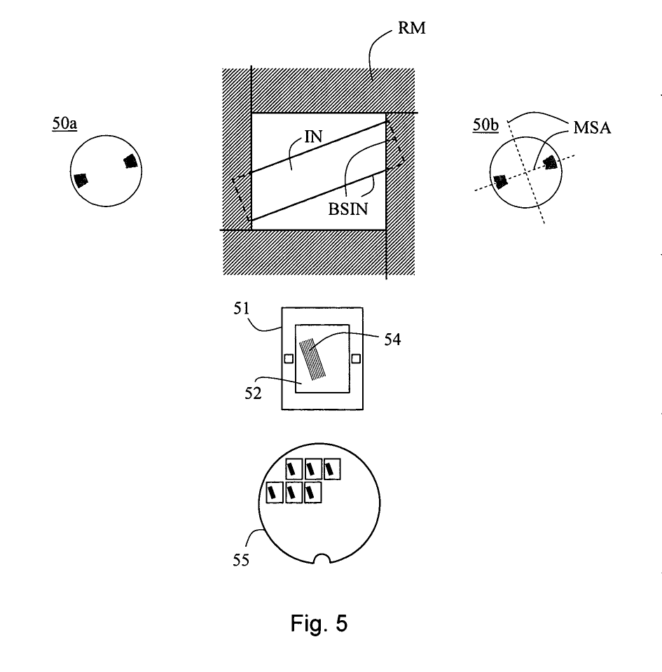

FIG. 5 illustrates a second aspect of the invention. Conventionally, the position and orientation of the reflective integrator IN such as for example a quartz rod is fixed in a lithographic apparatus. According to the invention, the reflective integrator IN is mounted rotatably around its axis, which usually coincides with the optical axis OPA of the lithographic apparatus, the amount of rotation corresponding to a desired amount of rotation of a pupil shape. For example, a rotated dipole 50a is provided in a pupil plane before the integrator IN. The integrator is set in a rotated position equal to the rotation of the dipole with respect to the horizontal X axis. In a pupil plane 50b after the integrator the pupil shape has become mirror-symmetric with respect to the central axes MSA parallel to the boundary segments of the cross-section of the reflective integrator, and since the integrator is also rotated, pupil 50b is substantially identical to pupil 50a. Such a rotated dipole is an optimal pupil shape for imaging line structures 54 in patterned area 52 on mask 51, the line structures oriented in a direction making an angle with the vertical Y axis, the angle being less than 90 degrees, for example being 30 or 45 degrees. Patterned area 52 is imaged on target portions on wafer 55. Notice that in this particular case, patterned area 52 equals the maximum usable area of mask 51.

The use of a rotated integrator implies that the illumination slit is rotated with respect to the mask and that the scan length in a scanning exposure increases. For example, for a slit size of 26×8 mm and a rotation angle of 20 degrees, the scan length increases by about 10 mm. A rotated slit also implies that the projection lens is preferably adjusted and optimized for a different field. If multiple angles of rotation of the integrator are used, the projection lens should be adjusted and optimized for a larger field, eventually the projection lens is preferably adjusted and optimized for its complete circular field.

As shown in FIG. 5, reticle masking blades RM define the illuminated area on the mask particularly in the horizontal X-direction. When the integrator IN is rotated, the two blades that define the horizontal size of the illuminated area are set such that the edges of the slit stay vertical. The maximum horizontal slit size and thereby the maximum horizontal die size decreases when the rotation of the integrator increases. Also, there is a little loss of intensity when the integrator is rotated as the blades block a certain part of the maximum illumination slit. For example, the intensity loss is about 10% for a rotation angle of 20 degrees.

1. A method for exposing a substrate using a lithographic apparatus, the method comprising:
providing a beam of radiation using an illumination system, the illumination system comprising part of the lithographic apparatus and including a reflective integrator disposed along an optical axis of the lithographic apparatus, the reflective integrator having a rectangular cross-section perpendicular to said optical axis;
imparting a pattern to the beam with a patterning device, the patterning device including a patterned area having features that extend in at least one direction parallel to a boundary segment of said cross-section of said reflective integrator, when viewed in a common plane perpendicular to the optical axis;
providing a substrate, the substrate comprising a radiation-sensitive layer and at least one target portion, said target portion being substantially rectangular; and
exposing the substrate such that, a first angle between a boundary segment of said cross-section of said reflective integrator and a boundary segment of said target portion is between 5 and 85 degrees, in a plane perpendicular to the unfolded optical axis.

2. A method according to claim 1, wherein said first angle is further of the form 90/n where n is an integer.

3. A method according to claim 1, wherein said patterning device has a maximum usable area, including said patterned area, and wherein during an exposure a second angle between a boundary segment of said target portion and a boundary segment of said maximum usable area is substantially equal to said first angle and wherein a third angle between a boundary segment of said cross-section of said reflective integrator and a boundary segment of said maximum usable area is substantially 0 degrees, in a plane perpendicular to the optical axis.

4. A method according to claim 3, wherein said target portion is rectangular and bounded by 4 line segments.

5. A method according to claim 3, wherein said target portion is an octagon bounded by 8 line segments of which 4 line segments coincide with boundary segments of said maximum usable area.

6. A method according to claim 1, wherein said patterning has a maximum usable area, including said patterned area, and wherein during an exposure a second angle between a boundary segment of said target portion and a boundary segment of said maximum usable area is substantially 0 degrees and wherein a third angle between a boundary segment of said cross-section of said reflective integrator and a boundary segment of said maximum usable area is substantially equal to said first angle, in a plane perpendicular to the optical axis.

7. A method according to claim 6, wherein said patterned area equals said maximum usable area.

8. A method according to claim 6, wherein a beam of radiation is provided with a pupil shape in a pupil plane on an object side of said reflective integrator, and wherein said pupil shape is symmetric with respect to two perpendicular central axes, said axes being parallel to respective boundary segments of said cross-section of said reflective integrator.

9. A patterning device having a maximum usable area, the maximum usable area including a patterned area, and wherein an angle between a boundary segment of said maximum usable area and a boundary segment of said patterned area is between 5 and 85 degrees.

10. A lithographic apparatus comprising:
a reflective integrator disposed along an optical axis of the lithographic apparatus, the reflective integrator having a rectangular cross-section perpendicular to said optical axis and being rotatable around said optical axis, a support structure to support a patterning device, the patterning device having a patterned area serving to impart a projection beam of radiation with a pattern in its cross-section, and a projection system to project said patterned area onto a target portion of a substrate.

11. A lithographic apparatus according to claim 10, wherein the illumination system further comprises an optical element for providing a beam of radiation with a pupil shape in a pupil plane before said reflective integrator, and wherein said pupil shape is mirror-symmetric with respect to two perpendicular central axes, said axes being parallel to respective boundary segments of said cross-section of said reflective integrator.

12. A lithographic apparatus according to claim 11, wherein said optical element is one of a diffractive optical element (DOE), a refractive optical element (ROE), and a holographic optical element (HOE).

13. A lithographic apparatus according to claim 11, wherein said optical element is rotatable around said optical axis.

14. A method for projecting features onto a substrate by a projection system having polarization dependent transmission characteristic, the features extending in at least a first and a second direction with respect to the substrate, comprising:
projecting a first patterned beam of radiation onto a target portion of a substrate having a radiation-sensitive layer, said first patterned beam comprising said features extending in said first direction with respect to said substrate;
rotating the substrate around an axis perpendicular to the substrate over an angle between said first and second directions after projecting the first patterned beam of radiation; and
projecting said second pattern onto said target portion of the substrate after said rotating, the second patterned beam of radiation comprising said features in said second direction with respect to the substrate.

15. A method according to claim 14, wherein the projection beam is substantially literally polarized in a particular polarization direction, and said first and second directions are arranged to be optimal for said particular polarization direction.

16. A method according to claim 14, wherein the substrate is rotated over an angle of 90 degrees.

17. A method according to claim 16, wherein said target portion is square.
